(19) United States
(12) Patent Application Publication
(10) Pub. No.: US 2012/0242536 A1
(43) Pub. Date: Sep. 27, 2012

(54) DOPPLER RADAR SYSTEM HAVING A HIGH PHASE NOISE TRANSMITTER

(75) Inventor: Alan Palevsky, Wayland, MA (US)

(73) Assignee: RAYTHEON COMPANY, Waltham, MA (US)

(21) Appl. No.: 13/072,282

(22) Filed: Mar. 25, 2011

(51) Int. Cl. G01S 13/00

(52) U.S. Cl. 342/159

(57) ABSTRACT

Disclosed herein are systems and methods for using high phase noise oscillators in Doppler radar systems. In some embodiments, a transmit pulse is sampled corresponding with a transmission time, and a phase noise correction factor is developed based on the sample transmit pulse and corresponding with the transmission time. A return echo is received that corresponds with the transmission time of the transmit pulse, and the return echo is modified based on the phase noise correction factor derived from the corresponding transmit pulse. In some embodiments, the transmit pulse can be generated from a magnetron or other high power oscillator having high phase noise. In some embodiments, the modified return echo is processed to differentiate clutter by resolving a Doppler shift.

### BACKGROUND

Embodiments relate to systems and methods for enhancing the performance of radar systems having high phase noise transmitters. More specifically, embodiments relate to systems and methods for utilizing high phase noise transmitters in Doppler radar systems.

Conventional radar systems include non-coherent, coherent, and pseudo-coherent systems. In non-coherent radar systems, a radar transmitter includes a modulator and a power oscillator, for example, a magnetron. Often, the power oscillator in non-coherent systems has an instable transmit frequency. The frequency instability may result in a frequency shift from one pulse to the next or frequency shift in an individual pulse. Non-coherent radar systems have the advantage of relatively low cost due to the relative low cost of the modulator and the unstable power oscillator. However, the unstable power oscillator, being an example of a high phase noise source, decreases the effectiveness of pulse-to-pulse evaluations on the return, such as those evaluations typical of Doppler radar systems, because the phase randomness of the power oscillator propagates through to the return.

In contrast to non-coherent radar systems, the transmit pulses of coherent radar systems, also referenced as coherent-on-transmit radar systems, are relatively stable with little or no phase variation between transmit pulses or within a transmit pulse. Coherent-on-transmit systems, such as the example coherent system 10 of FIG. 1, require a highly stable master oscillator 12 to obtain or maintain substantial stability of the phase from pulse to pulse. In coherent-on-transmit radar systems, a power-amplifier-transmitter (PAT) 14 is provided with relatively low phase noise. Examples of the PAT, e.g., a low-phase noise source, include a travel wave tube amplifier, a Klystron, or a solid-state or other high power amplifier, for example. While the PAT provides the advantage of low phase noise, coherent-on-transmit systems including a PAT are typically quite expensive. Though coherent radar systems are desirable for low phase noise applications, such as those for resolving Doppler shifts, the relatively high cost can be prohibitive, particularly in the context of independent or small business marine applications, for example.

Pseudo-coherent systems, such as the pseudo-coherent system 50 of FIG. 2, for example, are sometimes referred to as coherent-on-receive systems. The conventional pseudo-coherent system 50 includes a high phase noise source 52, e.g., a self-oscillating tube, and a phase sensitive detector 54 that mitigates the impact of transmit side phase noise at the return side before analog to digital conversion. Pseudo-coherent systems provide the advantage of utilizing a low-cost power oscillator that is typically a high phase noise source, such as a magnetron. However, the known pseudo-coherent system 50 is limited in its possible application to Doppler systems, where a plurality of pulse-pairs are evaluated for Doppler shift resolution.

### SUMMARY

Embodiments taught herein overcome the disadvantages and shortcomings of the prior art by providing a radar system in which a phase noise correction factor is developed from a transmit pulse sample n(t) and applied to the specific return echo n(t) that corresponds in time (t) with that particular transmit pulse sample n(t). In some embodiments, this can be accomplished by using an at least temporary memory to apply a delay on the transmit/sample side in order to offset the natural return-side delay associated with the round-trip travel of the emitted pulse and a corresponding return echo.

In some embodiments, a radar system is provided with an apparatus for compensating at the radar receive side for high phase noise at the radar transmit side, wherein the radar system comprises a radar signal processing subsystem. The radar signal processing subsystem can be configured to receive a sample of a transmit pulse corresponding to a transmission time thereof and to further receive a return echo corresponding with the transmit pulse for the transmission time. The radar signal processing subsystem can include a processor and an at least temporary memory, where the at least temporary memory is configured to store at least one of the transmit pulse sample and a phase noise correction factor corresponding with the transmission time. The processor can be programmable to modify the return echo based on the phase noise correction factor.

In some exemplary embodiments, a method is provided for sampling a transmit pulse that corresponds with a transmission time thereof. A phase noise correction factor can be calculated based on the sampled transmit pulse that corresponds with the transmission time. When a return echo is received that corresponds with the transmission time of the transmit pulse and the return echo is corrected based on the phase noise correction factor. In some embodiments, the modified return echoes are processed to differentiate clutter from a target. In some embodiments, the method is operated in the context of a fixed frequency system, and the target (or other target-based object) is differentiated from clutter by processing the corrected return echoes to resolve a Doppler shift.

In some exemplary embodiments, radar systems are provided for compensating a return echo at the receive side for high phase noise at the transmit side. The system can include a directional coupler or other means for sampling a transmit pulse corresponding to a transmission time thereof. A wave propagation subsystem, such as a duplexer-antenna combination, for example, is configured to emit the transmit pulse at the transmission time and receive a return echo corresponding with the transmit pulse for that transmission time. A radar signal processing subsystem can be provided with a processor and an at least temporary memory, e.g., flash memory storage, on-board random access memory (RAM), etc. The at least temporary memory is configured to store at least one of the transmit pulse sample and a phase noise correction factor derived therefrom, and the processor is configured to modify or correct the return echo based on the phase noise correction factor. In some embodiments, the transmit side of the system includes a high phase noise source, such as a magnetron or other unstable high power oscillator. The system can be provided as a fixed frequency system and can be configured to resolve Doppler shifts based on the modified return echoes.

In some embodiments, a radar signal processing system is provided for correcting a received radar echo due to high phase noise at the radar transmit side. The system at least comprises one or more computer-readable media having stored thereon computer-executable instructions for associating with a transmit pulse sample a phase noise correction factor corresponding to a transmit pulse having a transmission time associated therewith and, based on the phase noise correction factor, modifying a return echo corresponding to the transmit pulse and associated transmission time. The radar signal processing system can include components in addition to the at least one computer-readable media, and/or that the computer-executable instructions of the at least one computer readable media can be provided for additional and/or alternative performance.

In some embodiments, a method is provided for using a high phase noise transmitter in a radar system. In some embodiments, a transmit pulse corresponding with a transmission time thereof is sampled, and a phase noise correction factor is developed based on the sample transmit pulse and corresponding with the transmission time. A return echo is received corresponding with the transmission time of the transmit pulse, and the return echo is modified based on the phase noise correction factor.

Additional features, functions and benefits of the disclosed radar systems and methods will be apparent from the detailed description which follows, particularly when read in conjunction with the accompanying figures.

### BRIEF DESCRIPTION OF THE DRAWINGS

Reference is made to the following detailed description of exemplary embodiment(s) considered in conjunction with the accompanying drawings, in which:

FIG. 1 is a block diagram showing a prior art coherent radar system;

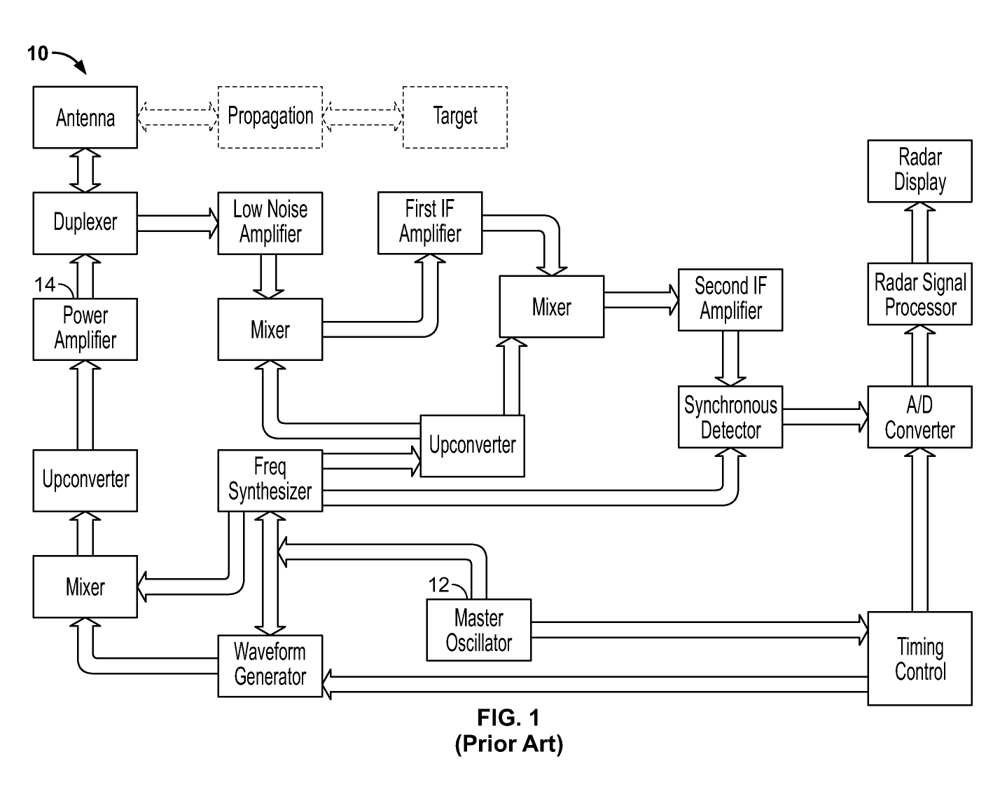

FIG. 2 is a block diagram showing a prior art pseudo-coherent radar system;

FIG. 3 is a block diagram showing a radar system constructed in accordance with an exemplary embodiment; and

FIG. 4 is a flow chart showing an exemplary embodiment of a method performed by the radar system of FIG. 3.

### DETAILED DESCRIPTION OF THE EXEMPLARY EMBODIMENTS

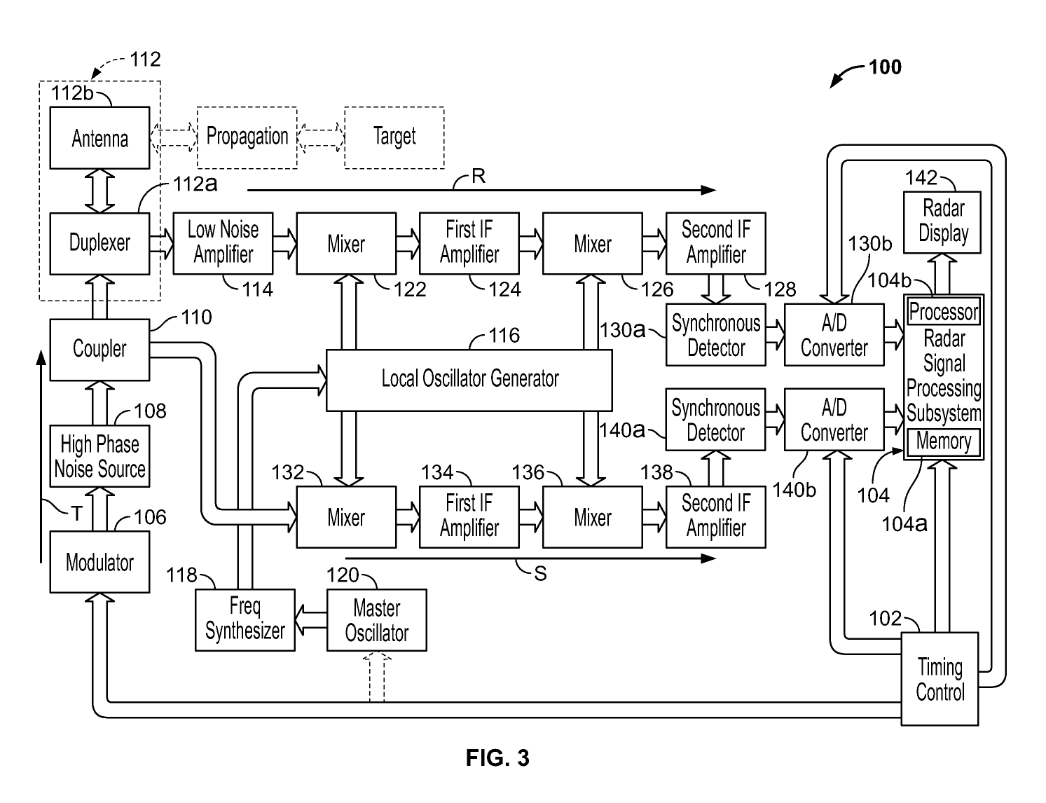

Referring to FIG. 3, a radar system 100 constructed in accordance with an exemplary embodiment is shown. As shall be described herein with further detail, the radar system 100 measures the actual phase noise on a sample of the transmit pulse, e.g., pulse n(t), relative to a stable oscillator on a pulse to pulse basis and corrects the received radar return echo on a pulse to pulse basis for a return n(t) that corresponds as a function of time with the pulse n(t). Providing A/D converters, which can be in the gigahertz ranges, for example, advantageously facilitate such correction. As shall be herein described, a memory is provided to at least temporarily store information corresponding with the transmit pulse sample at least until the corresponding return echo has been received and modified accordingly by an appropriate phase noise correction factor based on the stored information.

As used herein “phase noise” refers to phase fluctuations in a transmit pulse of a RADAR system. The phase fluctuations may be due to random frequency fluctuations of a power oscillator in a transmit chain of the RADAR system.

Continuing with reference to FIG. 3, the radar system 100 includes a timing control 102 for synchronizing a transmit side signal path (designated by the arrow T), a radar signal processing subsystem 104, and inputs thereto from a receive side signal path (designated by the arrow R), and a transmit sample signal path (designated by the arrow S), each of which shall be discussed in further detail below.

The transmit side signal path T includes a modulator 106 synchronized by the timing control 102. The modulator 106 generates a high power pulse of energy, which is received by a high phase noise source 108 coupled to the modulator 106. The high phase noise source 108 comprises a power oscillator, such as a magnetron or other high-noise oscillator transmitter generating random frequency fluctuations from one pulse to the next or within a pulse. The high phase noise source 108 outputs a burst of RF energy that is fed to a directional coupler 110. The directional coupler 110 propagates transmit pulses to the wave propagation subsystem 112, while directing a sample of each transmit pulse, which is propagated from the directional coupler 110 to the transmit sample signal path S, and which shall be described in further detail below.

The wave propagation subsystem 112 includes any hardware and/or software known in the art that is suitable for the purposes herein described. For example, the wave propagation subsystem 112 can include a duplexer 112a and an antenna 112b for providing both transmit and receive functionality. The duplexer 112a alternates cycles of the antenna 112b between emitting transmit pulses for propagation to a target and receiving return echoes propagated from the target and any clutter. It is contemplated that the wave propagation subsystem 112 can include separate and/or integral transmit and receive components.

Return echoes received by the wave propagation subsystem 112 are propagated along the receive side signal path R to a low noise amplifier 114 that amplifies the return echo to an appropriate level for further processing. As described further below, each amplified return echo undergoes in stepwise fashion one or more frequency downconversions while being mixed with a reference frequency from a stable local oscillator device (STALO).

Regarding generation of the reference frequency, a STALO is provided that is comprised of three components, e.g., a local oscillator generator 116, a frequency synthesizer 118, and a master oscillator 120. The local oscillator generator 116 is driven by the frequency synthesizer 118 which is driven by the master oscillator 120, and the master oscillator 120 may be synchronized to the timing control 102. Each return echo propagates from the low noise amplifier 114 to a first return side mixer 122, where it is mixed and downconverted in stepwise fashion with the signal from the local oscillator generator 116 of the STALO to form a first return side downconverted signal, which is propagated to a first return side IF amplifier 124. Each first return side downconverted signal is amplified by the IF amplifier to a first intermediate frequency return signal, which is propagated from the first return side IF amplifier 124 to a second return-side mixer 126, where the first intermediate frequency return signal is mixed and downconverted in stepwise fashion with the signal from the local oscillator generator 116 of the STALO to form a second return side downconverted signal, which is propagated to a second return side IF amplifier 128. The second return side IF amplifier 128 amplifies the second return side downconverted signal to output a second intermediate frequency return signal. In the embodiment of FIG. 3, each return echo is propagated from the second return side IF amplifier 128 to a return side synchronous detector 130a, which shall be described in further detail below.

Turning to further discussion of the directional coupler 110, a sample of each transmit pulse is coupled to propagate along the transmit sample signal path S for downconversion. Each transmit pulse sample propagates from the directional coupler 110 to a first sample side mixer 132, where it is mixed and downconverted in stepwise fashion with the signal from the local oscillator generator 116 of the STALO to form a first sample side downconverted signal, which is propagated to a first sample side IF amplifier 134. The first sample side IF amplifier 134 amplifies the first sample side downconverted signal and outputs a first sample side intermediate frequency signal. The first sample side intermediate frequency signal propagates from the first sample side IF amplifier 134 to a second sample side mixer 136, where the first sample side intermediate frequency signal is further mixed and downconverted in stepwise fashion with a signal from the local oscillator generator 116 of the STALO to form a second sample side downconverted signal, which is propagated to a second sample side IF amplifier 138. The second sample side IF amplifier 138 amplifies the second sample side downconverted signal to output a second sample side intermediate frequency signal. In the embodiment of FIG. 3, each second sample side intermediate frequency signal is propagated from the second sample side IF amplifier 138 to a sample side synchronous detector 140a.

Continuing with reference to FIG. 3, the sample side synchronous detector 140a extracts or determines the phase of each second sample side intermediate frequency signal and propagates the phase information to the A/D converter 140a. The return side synchronous detector 130a extracts or determines the phase of each second intermediate frequency return signal propagates the phase information to the A/D converter 130b. The A/D converter 130b on the return side signal path R, as well as the A/D converter 140b on the transmit sample signal path S, are both synchronized to the timing control 102.

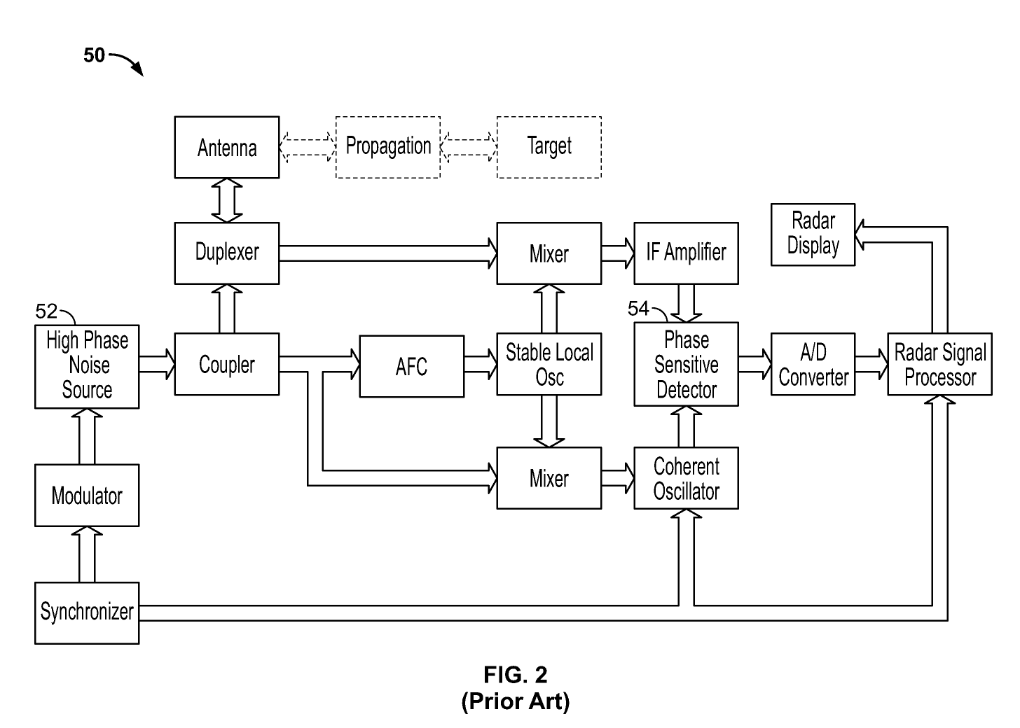

Referring for a brief moment to the prior art pseudo-coherent system 50 of FIG. 2, it is known for the phase sensitive detector 54 thereof to compare a return echo and a transmit pulse sample in an effort to mitigate the impact on the return of phase noise from the transmit side. However, such does not effectively compensate for the time delay associated with the return echo by virtue of the time needed for wave propagation between the antenna and target. As a result, there is a misalignment within pulse pairs, such that each pulse (e.g., n) is evaluated and corrected in comparison to an echo corresponding with a prior pulse (e.g., n−1), thereby not effectively accounting for pulse-to-pulse phase variations nor in pulse phase variations in the unstable oscillator of the high phase noise source 52.

Referring back to the radar system 100 of FIG. 3, which is constructed in accordance with an embodiment of the present application, for example, the radar system 100 provides for a time delay such that a transmit pulse sample n(t) corresponding to a transmission time (t) of the pulse can be effectively evaluated against a return echo n(t) corresponding to the transmit pulse n(t) for that transmission time (t). For example, the phase of a transmit pulse sample n(t) is propagated from the sample side synchronous detector 140a to a corresponding analog-to-digital (A/D) converter 140b to the radar signal processing subsystem 104 and stored, at least temporarily, in a memory device 104a thereof. Thereafter, for example, the phase of return echo n(t) is propagated from the return side synchronous detector 130a, to a corresponding A/D converter 130b, and to the radar signal processing subsystem 104. The radar signal processing subsystem 104 includes a processor 104a programmable and/or configurable to store and apply the phase information from synchronous detector 140a for the transmit pulse n(t), and, as a return echo n(t) corresponding with a transmission time (t) is received by the radar signal processing subsystem 104, the processor 104a retrieves from the memory 104b the phase information associated with the transmit pulse n(t) for correction and evaluation of the phase of the return echo n(t).

For each transmit pulse sample n(t), the radar signal processing subsystem 104 develops a phase noise correction factor n(t), which is facilitated by the common timing control 102 shared with the transmit side signal path T, for example. The radar signal processing subsystem 104 modifies the return echo n(t) based on the phase noise correction factor n(t). In some embodiments, the information stored in the memory 104a is the phase noise correction factor n(t), such that the processor 104b retrieves the phase noise correction factor n(t) from the memory 104a. Additionally or alternatively, the information stored in the memory 104a can be a representation of the transmit pulse sample n(t), which is thereafter retrieved by the processor 104b for contemporaneously developing a phase noise correction factor n(t) and comparing or correcting the corresponding return echo n(t) therewith. In this regard, the at least temporarily stored information can include information representative of the transmit pulse n(t), the transmit pulse sample n(t), the associated phase noise correction factor n(t), or any of the foregoing, and/or other information suitable for the systems and methods disclosed herein.

The modified return echo, e.g., the return echo corrected by the phase noise correction factor, provides a baseline for further processing. The radar signal processing subsystem 104 can, subsequent to such modification, for example, manipulate the modified return echo for any suitable processing. The modified return echo can be processed to differentiate a target from clutter by evaluating multiple pulses for resolution of a Doppler shift without overriding concern of uncorrected phase noise. The processed modified return echo can provide a target or any other suitable target-based object, such as a track (trajectory), for example. A radar display device 142 receives the processed modified return echo from the radar signal processing subsystem 104 (or other intermediate hardwired or programmed logic) for display of the target-based object.

The radar signal processing subsystem 104 can be provided in any suitable form known in the art. It is contemplated that the logic thereof for implementing the methods described herein can include at least one computer-readable media having stored thereon computer-executable instructions for performing the methods described herein. The computer-readable media can include hardwired logic and/or conventional portable media, e.g., programmable logic circuits (PLCs) and/or other integrated circuits, flash memory, etc. For example, it is contemplated that at least one computer-readable media can be provided with computer-executable instructions stored thereon for associating with a transmit pulse n(t) a phase noise correction factor n(t) corresponding to a time of transmission (t) of the transmit pulse n(t), and, based on the phase noise correction factor n(t), modifying a return echo n(t) corresponding to the time of transmission (t) of the transmit pulse n(t).

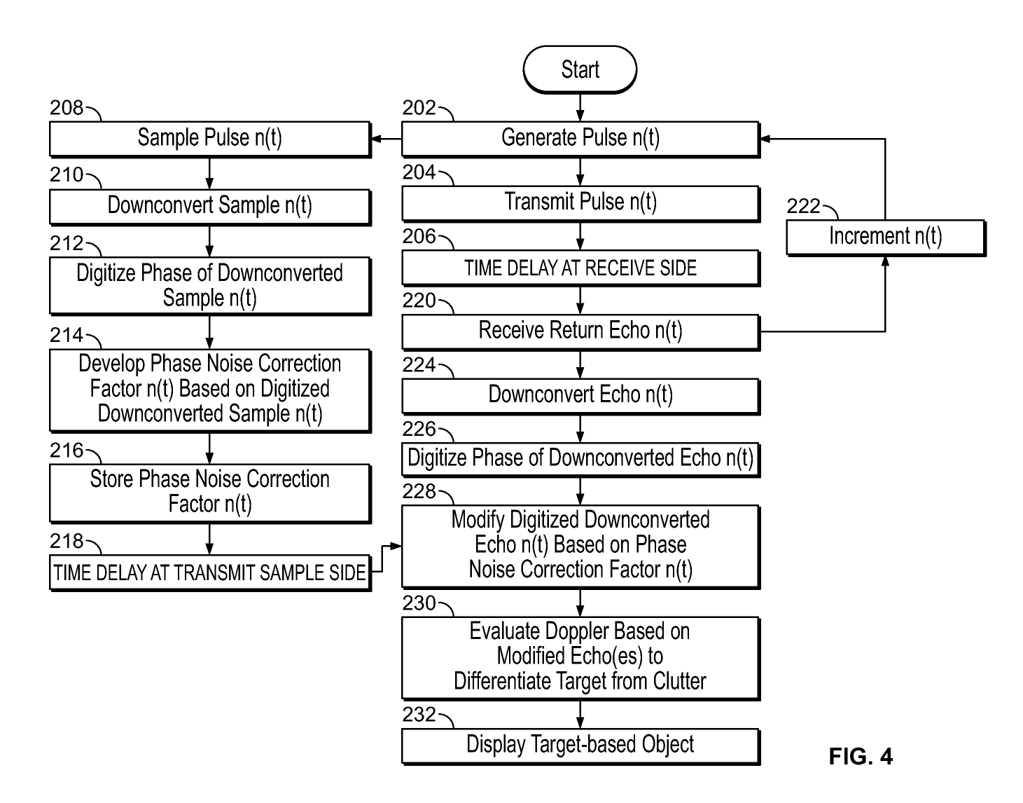

Referring to FIG. 4, a flow chart is provided showing an exemplary embodiment of a phase noise correction method 200. In some embodiments, the phase noise correction method 200 begins at step 202, where a transmit pulse n(t) is generated from a high noise power oscillator, such as a magnetron, for example. The phase noise correction method 200 proceeds from step 202 to step 204, where the transmit pulse n(t) is transmitted at a time of the transmission (t). Proceeding from step 204 to step 206, there is then a time delay on the receive-side signal path R of the radar system 100, while the transmit pulse n(t) propagates from the antenna 112b to the target and a corresponding echo n(t) propagates from the target to the antenna 112b. The received echo n(t) shall be discussed further below after first further discussing the transmit-side of the system 100.

At a time relatively contemporaneous with the time delay 206 of the receive-side signal path, for example, the phase noise correction method 200 also proceeds from step 202 to step 208. Turning attention to the transmit and sample signal paths T, S. At step 208, a transmit pulse sample n(t) corresponding to the transmit pulse n(t) is taken at the directional coupler 110 and propagated along the transmit sample signal path S to determine the phase of the transmit pulse. The phase noise correction method 200 proceeds from step 208 to step 210, where the transmit pulse sample n(t) is downconverted to a lower frequency and the phase is extracted or determined by the synchronous detector 140a, and from step 210 to step 212, where the phase of the transmit pulse sample n(t) is digitized using the A/D converter 140b, for example. The phase noise correction method 200 proceeds from step 212 to step 214. At step 214, the processor 104b, with reference to the common timing control 102 to which the transmit side signal path T and radar signal processing subsystem 104 are both synchronized, derives or calculates a phase noise correction factor n(t) based on the digitized phase value of the downconverted transmit pulse sample n(t).

Any suitable methodology can be used for developing the phase noise correction factor. Phase noise, similar to distortion or other noise more generally, is a quality that can be characterized as a complex I and Q modulation of an underlying signal. One example methodology is in a process similar to reverse encoding, whereby the phase noise correction factor can be developed by extracting the complex I and Q modulation information from a downstream signal on the transmit side signal path T relative to known parameters of the underlying signal.

The phase noise correction method 200 proceeds from step 214 to step 216, where the phase of the transmit pulse sample n(t) and/or the phase noise correction factor n(t) is at least temporarily stored in the memory 104a. The phase noise correction method 200 proceeds from step 216 to step 218, where a transmit-side time delay is provided to offset the time delay of step 220. In view of the receive-side time delay 220 associated with the travel time for wave propagation between the antenna 112b and target, a time delay 218 is provided on the transmit side, so that the return echo compared to the transmit pulse sample is that return echo n(t) corresponding to the time of transmission (t) to which the transmit pulse sample n(t) also corresponds. The phase noise correction method 200 proceeds from step 218 to step 228 for later utilization of the stored phase noise correction factor n(t), which shall be discussed in greater detail below after additional discussion of the return echo n(t).

Regarding the return echo n(t) and with additional reference to step 206 discussed above, there is a receive side time delay until such time as, at step 220, the return echo n(t) is received at the antenna 112b from the target. Regarding the next pulse, e.g., pulse n(t)+1, the phase noise correction method 200 proceeds from 220 to step 222, wherein n(t) is incremented, e.g., n(t)=n(t)+1 (and t=t+PRI, where PRI is or correlates to the pulse repetition interval (PRI)), and proceeds from step 222 to step 202, wherein the phase noise correction method 200 begins to prime the next pulse n(t)+1.

Regarding the pulse n(t) to which the present return echo n(t) corresponds, the phase noise correction method 200 proceeds from step 220 to step 224, wherein the return echo n(t) is downconverted to a lower frequency, and from step 224 to step 226, wherein the phase of the downconverted return echo n(t) is digitized using the A/D converter 130b after being extracted or determined by synchronous detector 130b.

The phase noise correction method 200, having taken into account a time delay associated with the stored phase noise correction factor n(t) at step 218, and having received the corresponding return echo n(t) and downconverted and digitized the phase of the same at steps 220, 224, 226, proceeds from steps 218 and 226 to step 228. At step 228, the processor 104b retrieves, for example, the stored phase noise correction factor n(t) from memory 104a and modifies the digitized phase of the downconverted return echo n(t) based on the phase noise correction factor n(t), and with reference to the common timing control 102 to which the transmit side signal path T is synchronized. The modified echo n(t) can then be further processed to accurately determine a Doppler shift using a high phase noise power oscillator.

Regarding the transmit-side time delay of step 218, such delay can be as long as needed for the return echo n(t) to be received at step 206 and is propagated through the receive side signal path R for modification by the phase noise correction factor at step 228. Regarding the duration of storage of the correction factor n(t) at step 216, it is contemplated that such duration can be as long as permanently. However, principles of efficiency and conservation of memory resources suggest that the memory 104a be provided with a first-in-first-out (FIFO) or other memory queue, such that the phase noise correction factor n(t) be stored at step 216 for only as long as needed to make the evaluation of step 228.

Continuing with additional reference to FIG. 4, the phase noise correction method 200 proceeds from step 228 to 230, where the return echo n(t) is processed in its modified echo n(t) form in view of the phase noise correction factor n(t). The radar system 100 can be provided as a Doppler radar-system with a high noise power oscillator, and a Doppler shift can be accurately resolved by evaluating the frequency of return echoes as modified by the phase noise correction factor n(t). The modified echo n(t) can be processed through conventional processing to distinguish clutter from a target (or other target-based object, such as a track). At step 232, the target-based object can be displayed by the radar display 142, for example.

It will be understood that the embodiments described herein are merely exemplary and that variations and modifications are possible without departing from the spirit and scope. All such variations and modifications, including those discussed above, are intended to be included within the scope as defined in the appended claims.

What is claimed is:

1. A radar system with apparatus for compensating at the radar receive side for phase noise at the radar transmit side, the radar system comprising:
a radar signal processing subsystem configured to receive a sample of a transmit pulse corresponding to a transmission time thereof and to further receive a return echo corresponding with the transmit pulse for the transmission time, the radar signal processing subsystem including a processor and an at least temporary memory, said at least temporary memory being configured to store at least one of the transmit pulse sample and a phase noise correction factor corresponding with the transmission time, and said processor being programmable to modify the return echo corresponding to the transmit pulse based on the phase noise correction factor.

2. The radar system of claim 1, further comprising a directional coupler for sampling the transmit pulse corresponding to the transmission time thereof.

3. The radar system of claim 1, further comprising a wave propagation subsystem configured to emit the transmit pulse at the transmission time and receive the return echo corresponding with the transmit pulse of the transmission time.

4. The radar system of claim 1, further comprising a high noise power oscillator configured to generate the transmit pulse.

5. The radar system of claim 4, wherein said power oscillator transmitter comprises a magnetron.

6. The radar system of claim 4, wherein said processor is programmable or configurable to develop the phase noise correction factor from the transmit pulse sample as an offset to correct a change in phase of the power oscillator transmitter.

7. The radar system of claim 1, further comprising first and second analog-to-digital converters respectively configured to digitize at least the phase of the return echo and the transmit pulse sample.

8. The radar system of claim 1, wherein said radar signal processing subsystem is programmable to process the modified return echo to differentiate clutter by resolving a Doppler shift.

9. The radar system of claim 8, wherein said radar signal processing subsystem is programmable to process from the modified return echo a target-based object.

10. The radar system of claim 9, further comprising a display configured to display a representation of the target-based object.

11. A radar signal processing system for correcting an echo received by a radar receiver corresponding to a transmit pulse with phase noise, the system comprising:
one or more computer-readable media having stored thereon computer-executable instructions for performing the following:
associating with a transmit pulse sample a phase noise correction factor corresponding to the transmit pulse and having a transmission time associated therewith; and
based on the phase noise correction factor, modifying a return echo corresponding to the transmit pulse and associated transmission time.

12. The radar signal processing system of claim 11, further comprising a processor programmed to execute the instructions stored on said one or more computer-readable media.

13. The radar signal processing system of claim 12, wherein said one or more computer-readable media is configured to have stored thereon at least one of the phase noise correction factor and the transmit pulse sample at least until return echo modification.

14. The radar signal processing system of claim 12, further comprising an at least temporary memory device configured to store at least one of the phase noise correction factor and the transmit pulse sample at least until return echo modification.

15. The radar signal processing system of claim 11, wherein said one or more computer readable media has stored thereon computer-executable instructions for performing the following:
calculating the phase noise correction factor based on the phase of the sample transmit pulse and corresponding with the transmission time.

16. The radar signal processing system of claim 15, wherein the phase noise correction factor is an offset to correct a change in phase of a high phase noise power oscillator generating the transmit pulse.

17. The radar signal processing system of claim 11, wherein said one or more computer readable media has stored thereon computer-executable instructions for performing at least one of the following:
storing the phase noise correction factor; and
storing the transmit pulse sample.

18. The radar signal processing system of claim 11, wherein said one or more computer readable media has stored thereon computer-executable instructions for performing the following:
processing the modified return echo, wherein said processing includes resolving a Doppler shift to differentiate clutter.

19. The radar signal processing system of claim 18, wherein said one or more computer readable media has stored thereon computer-executable instructions for performing the following:
processing from the modified return echo a target-based object; and
displaying the target-based object.

20. In a radar system, a method for using a transmitter with phase noise, the method comprising:
sampling a transmit pulse output from the transmitter corresponding with a transmission time thereof;
developing a phase noise correction factor based on the sample transmit pulse and corresponding with the transmission time;
receiving a return echo corresponding with the transmission time of the transmit pulse; and
modifying the return echo based on the phase noise correction factor.

21. The method of claim 20, further comprising, prior to said sampling, generating the transmit pulse from a high phase noise power oscillator.

22. The method of claim 21, wherein the phase noise correction factor is an offset to correct a change in phase of the high phase noise power oscillator.

23. The method of claim 20, comprising storing the phase noise correction factor.

24. The method of claim 23, wherein said storing comprises storing the phase noise correction factor in a memory at least until after said modifying.

25. The method of claim 20, comprising storing the transmit pulse sample.

26. The method of claim 20, further comprising converting a phase of the return echo to digital format and converting a phase of the transmit pulse sample to digital format.

27. The method of claim 20, further comprising processing the modified return echo, wherein said processing includes resolving a Doppler shift to differentiate clutter.

28. The method of claim 27, wherein said processing further includes:
processing from the modified return echo a target-based object; and
displaying the target-based object.
